(19) United States
(12) Patent Application Publication
(10) Pub. No.: US 2009/0105323 A1
(43) Pub. Date: Apr. 23, 2009

(54) TREATMENT OF EDIBLE CROPS

(76) Inventor: William Bliss, Victoria (AU)

Correspondence Address: EDWIN D. SCHINDLER, FIVE HIRSCH AVENUE, P.O. BOX 966, CORAM, NY, 11727-0966, US

(21) Appl. No.: 12/301,079

(22) PCT Filed: May 18, 2006
(86) PCT No.: PCT/AU07/00694

§ 371 Date: Nov. 17, 2008

(30) Foreign Application Priority Data
May 18, 2006 (AU) 2006902660

(51) Int. Cl. A01N 43/50

(52) U.S. Cl. 514/389

(57) ABSTRACT

In the growing of crops for consumption, a method for the removal of pathogens includes the addition to irrigation water for the crops of an anti-pathogen composition and supplying the anti-pathogen composition to the crops prior to harvest while normal irrigation is effected. The anti-pathogen composition is based on halogens, such as chlorine, bromine and iodine, or mixtures of halogens or halogens combined with other organic radicals including cyanurate, hydantoin, peroxide and chlorine dioxide. BCDMH and TICA are preferred anti-pathogen components of the anti-pathogen composition and may be added to a carrier concentrate and measured and dosed into the irrigation water.

### TECHNICAL AREA

This invention relates to the treatment of edible crops and, in particular, to pre-harvest treatment of such crops.

### BACKGROUND OF THE INVENTION

A very large proportion of edible crops are irrigated by overhead sprays. Crops grown in proximity of urban areas may utilize potable mains water for this use. However due to the expansion of urban population traditional vegetable growing areas are being displaced to areas where irrigation supplies are dependant on dams or rivers.

Surface water as above is contaminated by livestock, poultry and misdirected sewage effluent.

This contamination results in a growth of undesirable human pathogens in the water supply.

The trend to recycle drainage water and run off from the growing area to conserve water, results in increasing the level of plant pathogens in the irrigation supply.

Total Plate Count (TPC) of this water will give a typical figure of 10⁶ of Colony Forming Units CFU/ml indicating a high level of contamination. In addition faecal contamination will show coliform counts of 10¹-10³/ml.

In developed countries the general requirements for ready to eat foods is for a TPC of 10³/gm or less and nil coliforms. Quite obviously the contaminated irrigation water is not helping achieve the food safety requirement.

A further issue in terms of food safety is pesticide residues. As most vegetable crops require generous watering this increases the humidity adjacent the crop and, in turn, results in prime conditions for fungal diseases.

Many of these diseases develop very rapidly and a whole crop can be wiped out in a few days.

While a pesticide spray would control the fungal problem it may leave a residue on the crop at harvest.

The residue, at the time of harvest, cannot exceed the Maximum Residue Level (MRL). To avoid exceeding the MRL a time interval is determined between spraying the pesticide and harvest. This time is called the Withholding Period.

Consequently, if a fungal problem occurs close to harvest it may not be possible to use any pesticide on the crop because of the withholding period.

### OUTLINE OF THE INVENTION

The object of the present invention is to provide a means whereby edible crops can be treated for the removal of human and plant pathogens from their surfaces prior to harvest with a lesser withholding period than has presently been the case so treatment can occur much later than is the case using pesticides.

The invention includes in the growing of crops for consumption, the removal of pathogens by the addition to irrigation water for the crops of an anti-pathogen compound and supplying this to the crop prior to harvest whilst normal irrigation is effected.

It is preferred that the anti-pathogen material be based on halogens such as chlorine, bromine and iodine or mixtures of halogens or halogens combined with other organic radicals including cyanurate, hydantoin, peroxide and chlorine dioxide. In addition it is required that the active ingredient be measured and dosed with a sensing probe such as ORP.

It is preferred that the anti-pathogen material be BCDMH or TICA, and it is also preferred to make a concentrate of this product with a solvent, which concentrate can be metered into the irrigation water. In one particular form of the invention we use Di Acetone Alcohol or other high-molecular weight solvent and we may also use a Silica Drier if this is required.

### DESCRIPTION OF AN EMBODIMENT OF THE INVENTION

In order that the invention may be more readily understood, we shall describe one particular form of the invention.

It is often necessary to remove human and plant pathogens from the surface of edible crops and in many applications the crops, after harvest, go through a treatment process which may include dipping or spraying with a anti-pathogen material, such as, BCDMH (Bromo Chloro Di Methyl Hydantoin) or TICA (Trichloro Iso Cyanuric Acid). This means that the crops, after harvest, and still carrying substantial quantities of pathogens are transported to a treatment site, with the possibility that cross-contamination from the untreated crops can occur.

BCDMH is currently registered in Australia and New Zealand for the control of plant and human pathogens on fruit and vegetables by washing, dipping or spraying as a post harvest treatment.

We propose to treat the crop before harvest with these products and this will reduce the quantity of pathogens which are carried with the newly harvested material, which would normally still pass through a post harvest treatment although, in some cases, this may not be necessary.

The withholding period in this use pattern is 15 minutes, when BCDMH is used at 5-22.5 PPM as chlorine. Current fieldwork indicates-that a few “troublesome” crops may require higher rates of 50-100 PPM as chlorine, which could extend the withholding period to 60 minutes.

These periods are very much shorter than possible from normal pesticides and thus crops can be treated much closer to harvest than has previously been the case.

As described, the preharvest irrigation water containing BCDMH would reduce the pathogen level on all wetted surfaces of the crop.

The formulation described in this invention allows the product to be used in water or in mineral oil as for misting bananas. Other vegetable oils eg. Canola are used with pesticides. Another development is synthetic oils or materials such as polysilicones. The formulation is designed for addition to such systems.

We provide a base concentrate material and in one particular arrangement this may comprise

| | | |
|---|---|---|
| Di Acetone Alcohol | 1 | Litre |
| BCDMH | 350 | grams |
| Silica Drier | 10 | gram |

Whilst in this particular formulation we use Di Acetone Alcohol, the solvent may be any other high molecular weight solvent, such as Glycol Alcohols or Glycol Ethers, the basic requirement be that the solvent, or any residue which it leaves, is non-toxic.

The BCDMH can be replaced by TICA or other suitable anti-pathogen compound.

The concentrate may, if required, be diluted with a compatible mineral, plant or animal oil prior to use, or the concentrate is miscible with water in all proportions. In an emulsion this will permit the disinfectant to be present in either oil or water phase or both.

The concentrate may be mixed with the irrigation water used for a number of different types of irrigation.

For example, it is particularly useful for treatment when applied through overhead sprinkler or spray irrigation systems or other forms of spray units. This tends to bring the material into contact with the crop from above, so there is good coverage of the crop.

When the product is to be used to control soil borne plant pathogens, it can readily be applied by flood, furrow, overhead or trickle irrigation systems.

Where it is to be used on the surface of crops, it can also be applied by land-based spray or misting equipment or be delivered by rotary or fixed wing aircraft.

Whilst the concept of the invention appears to be deceptively simple, it provides a completely new direction of human and plant pathogen control.

Whilst in this specification we have described one particular formulation, it is to be understood by person skilled in the art, that wide variations could be made in this to give the required end result.

1-14. (canceled)

15. A method for removing pathogens from crops being grown and intended for human consumption, comprising the steps of:
adding a pathogenic composition to irrigation water for crops being grown and intended for human consumption, the pathogenic composition including a halogen-based component selected from the group consisting of a halogen compound having chlorine, a halogen compound having bromine, a halogen compound having iodine and a combination thereof, for forming a pathogenic irrigation water composition; and,
irrigating the crops with the pathogenic irrigation water composition prior to harvesting the crops.

16. The method for removing pathogens from crops being grown and intended for human consumption according to claim 15, wherein said pathogenic composition further comprises halogens combined with organic radicals selected from the group consisting of cyanurate, hydantoin, peroxide, chlorine dioxide and a combination thereof.

17. The method for removing pathogens from crops being grown and intended for human consumption according to claim 15, wherein the pathogenic composition includes BCDMH.

18. The method for removing pathogens from crops being grown and intended for human consumption according to claim 15, wherein the halogen-based component includes a halogen compound having chlorine with BCDMH being included in an amount ranging from 5 to 100 ppm as chlorine.

19. The method for removing pathogens from crops being grown and intended for human consumption according to claim 18, wherein the halogen-based component includes a halogen compound having chlorine with BCDMH being included in an amount ranging from 5 to 22.5 ppm as chlorine, and with a withholding period of 15 minutes.

20. The method for removing pathogens from crops being grown and intended for human consumption according to claim 18, wherein the halogen-based component includes a halogen compound having chlorine with BCDMH being included in an amount ranging from 50 to 100 ppm as chlorine, and with a withholding period of 60 minutes.

21. The method for removing pathogens from crops being grown and intended for human consumption according to claim 18, wherein the pathogenic composition further includes a silica drier.

22. The method for removing pathogens from crops being grown and intended for human consumption according to claim 15, wherein said pathogenic composition further includes TICA as an anti-pathogen component.

23. The method for removing pathogens from crops being grown and intended for human consumption according to claim 15,

24. The method for removing pathogens from crops being grown and intended for human consumption according to claim 15, further comprising the steps of:
adding the pathogenic composition to a solvent; and,
metering the pathogenic combined with the solvent into the irrigation water.

25. The method for removing pathogens from crops being grown and intended for human consumption according to claim 24, wherein the solvent includes di-acetone alcohol.
